(19) United States
(12) Patent Application Publication
(10) Pub. No.: US 2011/0042323 A1
(43) Pub. Date: Feb. 24, 2011

(54) OIL RECOVERY SYSTEM AND APPARATUS

(76) Inventor: Myron Sullivan, II, West Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/867,727

(22) PCT Filed: Feb. 16, 2009
(86) PCT No.: PCT/CA09/00186

§ 371 Date: Nov. 1, 2010

Related U.S. Application Data
(60) Provisional application No. 61/029,314, filed on Feb. 16, 2008.

(51) Int. Cl. E02B 15/04; C02F 1/40; E02B 15/10

(52) U.S. Cl. 210/744; 210/747; 210/122; 210/242.3

(57) ABSTRACT

A system and method for cleaning oil spills from the surface of a body of water involves deploying a plurality of remotely guided self-propelled floating liquid hydrocarbons collection and separation apparatus, floating liquid hydrocarbons retention booms and floating liquid hydrocarbons storage devices, moving the liquid hydrocarbons boom to contain the liquid hydrocarbons, moving the liquid hydrocarbons collection and separation apparatus by remote guidance into the contained liquid hydrocarbons and operating the apparatus to separate the liquid hydrocarbons from the water, and pumping the separated liquid hydrocarbons into the floating liquid hydrocarbons storage devices.

### REFERENCE TO RELATED APPLICATIONS

The present application claims the benefits, under 35 U.S.C. §119(e), of U.S. Provisional Application Ser. No. 61/029,314 filed Feb. 16, 2008 entitled “Oil Recovery System and Apparatus” which is incorporated herein by this reference.

### TECHNICAL FIELD

The present invention relates to the recovery of liquid hydrocarbons from spills principally in marine environments, rivers or lakes. More particularly, the invention relates to an apparatus for collecting and separating liquid hydrocarbons from water in the event of an oil spill, and a system for employing such apparatus and storing the collected liquid hydrocarbons.

### BACKGROUND

Oil spills cause severe environmental damage. As oil exploration, offshore drilling and oil production and crude oil shipping reach ever increasing magnitudes and ever more sensitive environments, rapid response to oil spills is of increasing importance. Rapid containment and recovery of a spill is critical to minimize environmental damage and cleanup costs. While numerous oil containment and recovery apparatus and systems have been developed, existing systems have insufficient capacity, require too much time to deploy, and are ineffective in adverse weather, rough seas or conditions of limited visibility such as fog or night-time.

A central element of any oil spill cleanup system is an apparatus for “skimming” and separating oil from the water. This is typically done using conventional weir or disc skimmers. However existing skimmers have too little capacity, are too slow and difficult to deploy to be effective particularly for large oil spills, and are limited in the environmental conditions under which they can operate effectively.

The present inventor has disclosed an oil recovery system in U.S. Pat. No. 5,075,014. The present disclosure describes improvements to that system.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides an apparatus for collecting and separating liquid hydrocarbons from the surface of a body of water comprising: a) a housing forming an interior space for receiving a volume of liquid and provided with flotation means, the housing having an entrance aperture adjacent the water surface adapted to admit an uppermost layer of liquid hydrocarbons and water from the water surface to the interior of the housing, and an exit aperture adapted to permit the flow of water from the housing; b) means within the housing for collecting a flow of liquid from the surface layers of the liquid hydrocarbons and water in the interior of the housing and directing the liquid to first pump means; c) means for maintaining said means for collecting at a selected depth; and d) second pump means for evacuating water from said exit aperture. The apparatus may also include a liquid hydrocarbons-water separator mounted in said housing, and connected to means for discharging separated liquid hydrocarbons from the housing to a means for storage of recovered separated liquid hydrocarbons.

The invention further provides a method of collecting liquid hydrocarbons from the surface of water, and separating the liquid hydrocarbons from the water comprising: a) providing a floating liquid hydrocarbons collection and separation apparatus as described above, floating liquid hydrocarbons retention boom means and floating liquid hydrocarbons storage means; b) moving said liquid hydrocarbons boom means to contain the liquid hydrocarbons; c) moving the liquid hydrocarbons collection and separation apparatus into the contained liquid hydrocarbons and operating the apparatus to separate the liquid hydrocarbons from the water; and d) pumping the separated liquid hydrocarbons into the floating liquid hydrocarbons storage means. The liquid hydrocarbons boom means, liquid hydrocarbons collection and separation apparatus and liquid hydrocarbons storage means may be dropped onto the surface of water from the air in one embodiment providing rapid deployment, or by ship or tractor-trailer. By employing oil separation methods, the invention is sufficiently compact and appropriate for airborne systems, unlike conventional oil collection apparatus.

The present invention further provides an apparatus for collecting and separating liquid hydrocarbons from the surface of a body of water comprising: a) a weir skimmer for the collection of a volume of liquid adapted to admit an uppermost layer of liquid hydrocarbons and water from the water surface to the skid mounted oil-water separator, and an exit aperture adapted to permit the flow of water from the housing to return to the environment and oil from the housing to separate storage tanks; b) and means within the skid mounted assembly for collecting a flow of liquid from the surface layers of the liquid hydrocarbons and water from the weir and directing the liquid to a first pump. The apparatus may also include a liquid hydrocarbons-water separator mounted in the skid assembly, and connected to means for discharging separated liquid hydrocarbons from the housing to a means for storage of recovered separated liquid hydrocarbons.

The invention further provides a method of collecting liquid hydrocarbons from the surface of water, and separating the liquid hydrocarbons from the water comprising: a) a floating liquid hydrocarbons collection weir and skid mounted separation apparatus assembly as described above, and land based hydrocarbons storage means; b) operating the apparatus to separate the liquid hydrocarbons from the water; and c) pumping the separated liquid hydrocarbons into the land based liquid hydrocarbons storage means. The liquid hydrocarbons weir may be dropped onto the surface of water from the skid by a hydraulic arm or small crane in one embodiment providing rapid deployment. By employing oil separation methods, the invention is sufficiently compact for trailer transport on roads and highways, unlike conventional oil collection apparatus.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is an elevation view, in partial section, of the liquid hydrocarbons collection and separation apparatus in accordance with the present invention.

FIG. 2 is a plan view, with the canopy removed, along direction lines 1-1 of FIG. 1.

FIG. 3 is an end view, along the direction of lines 2-2 of FIG. 1.

FIG. 4 is a detail elevation view of the inlet funnel and articulated arm with a fuel tank removed and cladding plates partially broken away.

FIG. 5 is a perspective view of a first liquid hydrocarbons spill recovery system incorporating an airplane-deployable version of the apparatus of the present invention in operation in the early stages of a typical oil spill cleanup operation.

FIG. 6 is a perspective view of a second oil spill recovery system incorporating a number of the apparatus of the present invention in operation at a later stage of a large oil spill cleanup operation.

FIG. 7 illustrates a typical GRG Robotic AUV Boom Tug 312 towing an oil spill containment boom 310.

FIG. 8 illustrates the hydrocarbon recovery vehicle 10 oil-water separation system.

FIG. 9 illustrates the hydrocarbon recovery vehicle 10 Oil-Water Separation System output.

FIG. 10 is a schematic of the AEROS Airborne Robotic Oil Spill Recovery System, depicting the relative arrangement of Boom Tugs 312, Hydrocarbon recovery vehicle 10, Floating oil collection tank 35, and the oil spill containment boom 310.

FIG. 11 illustrates the recovery of the AEROS System vehicles and equipment.

FIG. 12 is an assembly view of a second embodiment of the invention being a skid mounted assembly, including an isometric view, basic dimensions and a listing of major components.

FIG. 13 is an isometric view, showing the location of major components of the embodiment shown in FIG. 12.

FIG. 14 is top view and side view showing the location of major components of the embodiment shown in FIG. 12.

FIG. 15 is solid model isometric view showing general piping schematics and major components of the embodiment shown in FIG. 12.

FIG. 16 is a detail view of the frame showing general construction, suggested material and dimensions of the embodiment shown in FIG. 12.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

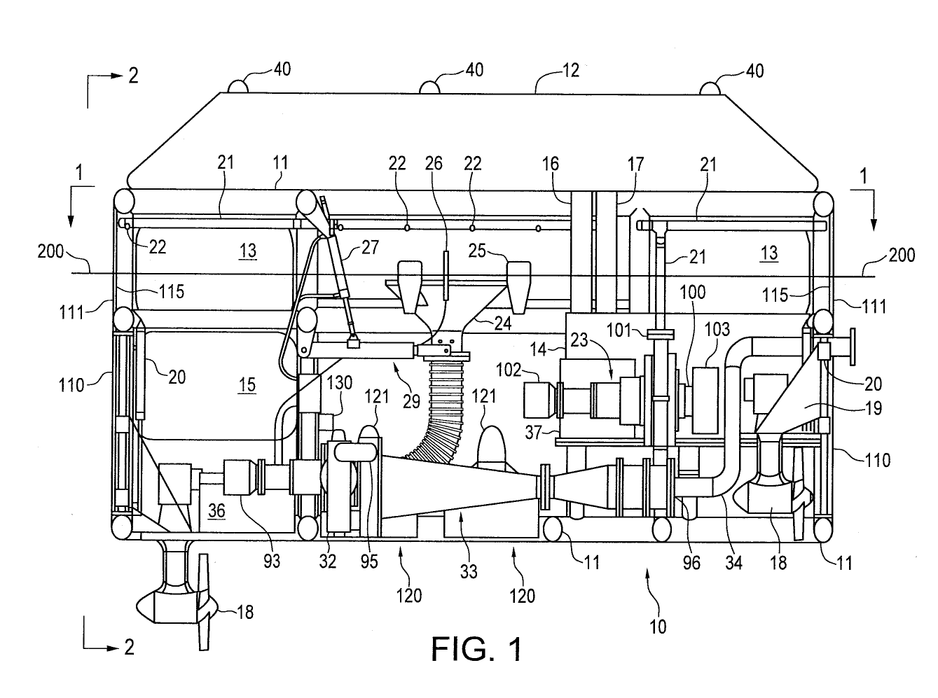

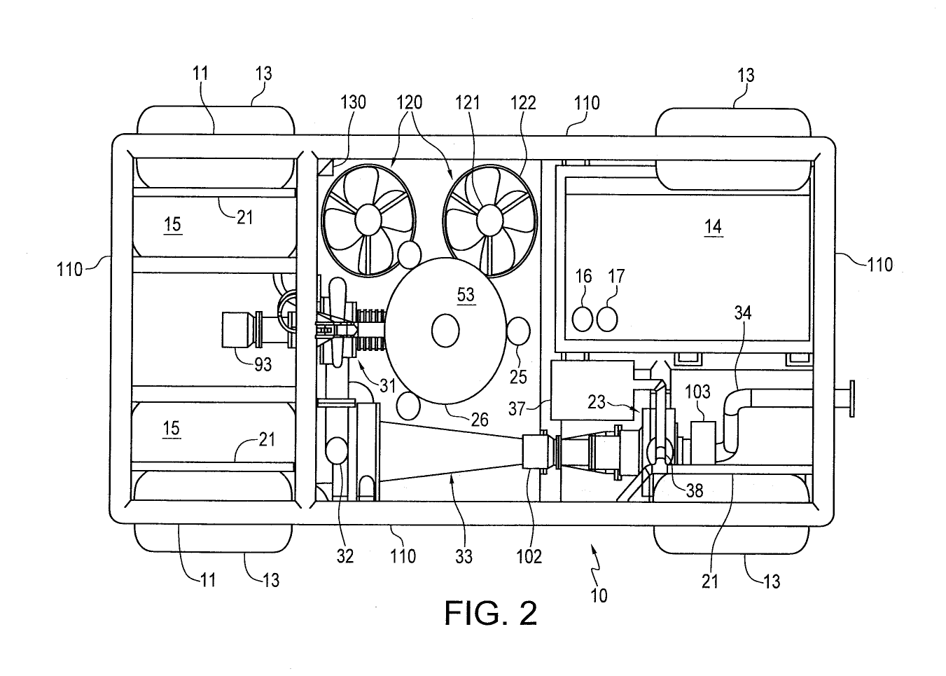

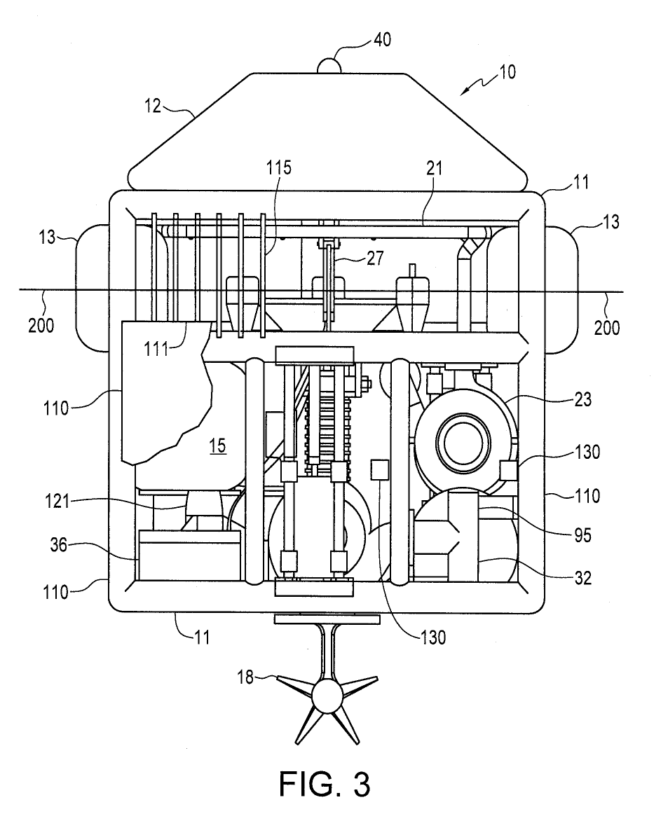

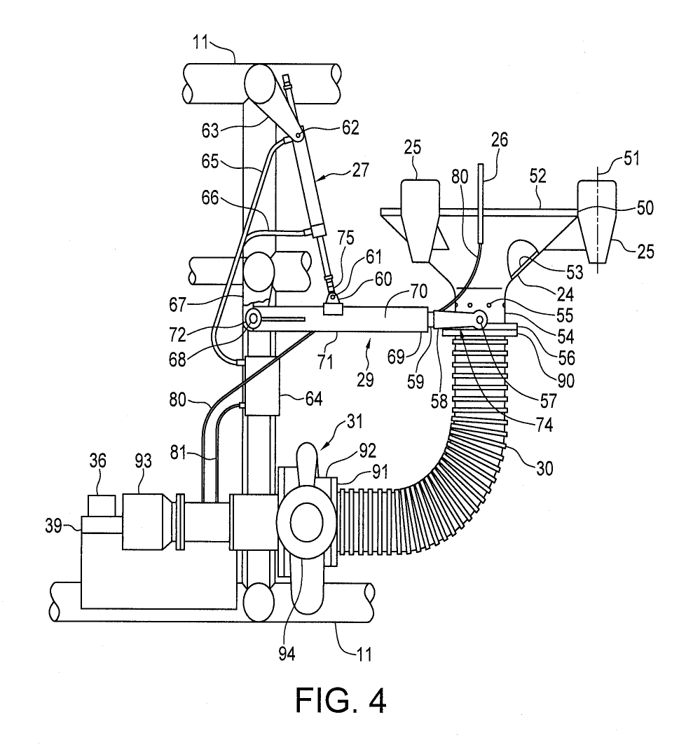

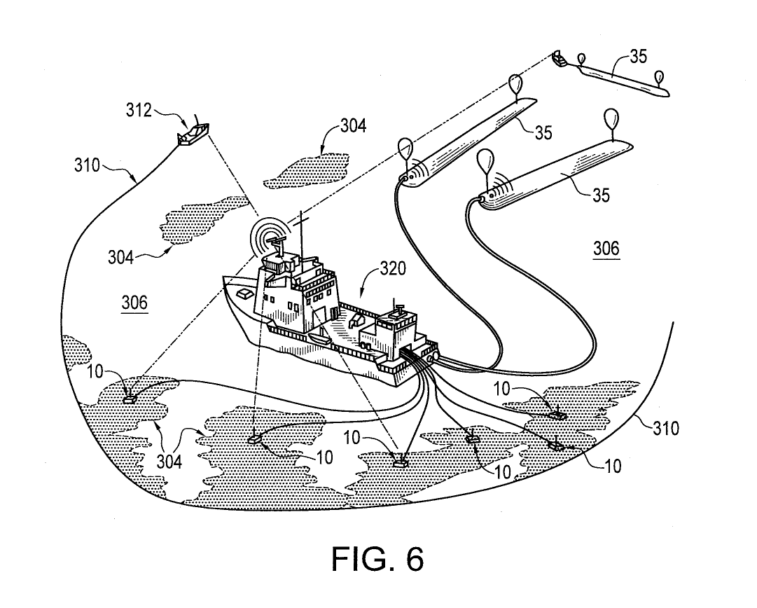

FIGS. 1 through 4 show the overall configuration of the liquid hydrocarbons collection and separation apparatus 10 in accordance with a first embodiment of the present invention. The apparatus 10 includes generally a frame 11, a canopy 12, flotation tanks 13, an enclosed power-pack 14, fuel tanks 15, a power-pack breather tube 16, a power-pack exhaust pipe 17, 360° steerable Z-drive 18 such as that sold under the trademark Olympic, thruster mounting frames 19, thruster deployment cylinders 20, high-pressure water spray system piping 21, spray funnels 22, high-pressure spray system pump 23, a converging funnel or funnel 24, funnel flotation tanks 25, air/liquid hydrocarbons/water level sensors 26, a funnel depth control cylinder 27, an articulated arm 29, a flexible hose 30, a centrifugal pump 31, separator inlet distribution piping 32, a liquid hydrocarbons/water separator 33, liquid hydrocarbons discharge piping 34, flexible liquid hydrocarbons collection bag 35 (shown in FIG. 6), enclosed electronics module 36, a chemical de-emulsifier tank 37 with control valve 38, and GPS unit and serial bus 39.

While it is contemplated for the preferred embodiment that the power pack 14 is diesel powered, in which case the tanks 15 hold diesel fuel, it is apparent that other sources of power such as gasoline or electricity may be used. In addition, solid polymer fuel cells utilizing cryogenic oxygen and hydrogen as fuel may also be used instead of a diesel powered internal combustion engine. Tanks 15 may be inflatable to preserve the buoyancy of the vehicle. The power pack 14 provides hydraulic power to the various devices. A 360° steer able Z-drive 18 has been deployed downwardly into operative position in FIG. 1 on a vertical guide by cylinder 20. It can be rotated horizontally through 360 degrees. A second steerable Z-drive 18 remains in the recessed position in FIG. 1. The steerable Z-drive 18 can rotate a full 360° within two seconds, allowing the separation apparatus 10 full range of directional control. Sensors 26 are standard capacitance-measuring level sensors of existing design.

Centrifugal separator 33 is preferably of the type disclosed in U.S. Pat. No. 4,859,347 issued Aug. 22, 1989 to Simon et al.

In the first embodiment, frame 11 is a structure, comprised of welded tubing, of a generally box-like nature, to which are attached by mechanical fastener means the flotation tanks 13, the power-pack system elements 14, 16 and 17, the fuel tanks 15, the thruster systems elements 18, 19 and 20, the high-pressure water spray system elements 21, 22 and 23, the liquid hydrocarbons/water collection funnel system elements 24 to 30, the liquid hydrocarbons/water centrifugal pump 31, the liquid hydrocarbons/water separator system elements 32 and 33, the separated-liquid hydrocarbons collection system element 34, the electronic control module 36, and the de-emulsifier storage tank 37. Navigation lights 40, provide visibility by other ships and help prevent collisions at sea, and assist in retrieval of the apparatus 10.

The converging funnel 24 has from three to six (preferably three) flotation tanks 25 attached to its periphery 50, the tanks being spaced generally equally about the periphery with one being placed diametrically opposite the articulated arm 29 as shown in FIG. 1. The flotation tanks 25 are cylindrical, having a vertical axis 51, and are of such radius at the water level 200 that they provide minimal impedance to the flow of liquid hydrocarbons and water over the funnel lip 52. Their purpose is to maintain the plane of the funnel lip 52 parallel to the surface of the water. They have sufficient flotation that they provide sufficient buoyancy to maintain the level of the funnel when the funnel 24 is submerged to its anticipated maximum or minimum depth.

The opening of funnel 24 is preferably covered with a wire mesh, with square mesh spacing approximately 10 centimeters across, which acts as a second stage debris barrier. To keep the mesh open, a mesh-cleaning metal bar (not shown) can be pivotally attached at one point on lip 52 of funnel 24 in order to scrape over the top surface of the mesh in a fashion similar to an automobile windshield wiper. The wiping or sweeping action of the mesh-cleaning bar may be power-operated and serves to break up agglomerations of highly-viscous oil and force the oil through the mesh into funnel 24. The surface of the mesh-cleaning bar may be coated with a liquid hydrocarbons-inert synthetic material having a low co-efficient of friction.

The funnel 24 is formed of a lip 52 that connects to a conically converging interior surface 53 that in turn connects to the anterior part of a generally cylindrical throat portion 54, which has a series of small holes 55 in a radial pattern disposed about the central axis of the funnel. Holes 55 allow, when the apparatus is initially placed in the water, to recover liquid hydrocarbons from a spill, water to flow from the exterior of the funnel 24 to the interior, the water then filling the flexible hose 30 and flooding the suction intake port 92 of the centrifugal pump 31. The holes 55 are sized so that the flow rate of water through the holes is insignificant in comparison with the total flow rates of liquid hydrocarbons and water over the funnel lip 52 when the apparatus of the present invention is in full operation. The posterior part of the throat 54 is connected to a flange 56. Substantially adjacent the flange 56 and extending to the outer diameter of the flange 56 are two “bosses” (not shown), diametrically opposed, at right angles to the center line 70 of the articulated arm 29 and each capable of receiving one end of a pin 57. Vertical baffle plates radiating outwardly from funnel 24 may be positioned submerged or partially submerged below the water level on frame 11 to prevent surface backwash effect in the liquid hydrocarbons.

The articulated arm 29 is comprised of a cylindrical metal tube or shaft 71, a bearing assembly 72 attached to one end of tube 70 such that the centerline of the bearing assembly 72 is at right angles to the center line 70 of the shaft 71, a bearing assembly 69 at the other end of the shaft 71 with the center line of bearing assembly 69 parallel to center line 70, two pins 57, and a U-shaped yoke element 74 comprised of a stub shaft 59 and two arms 58. The stub shaft 59 is affixed to the midpoint of the U-shaped yoke element 74 with the shaft center line lying substantially in the plane defined by the arms 58. The stub shaft 59 extends in a direction opposed to the general direction of the arms 58, and mates with the bearing assembly 69, and is mechanically retained therein, the bearing assembly 69 and stub shaft 59 in combination providing a rotating joint for the articulated arm 29. Means are provided for fixing pins 57 at the ends of the yoke arms 58, said pins mating with the bosses and securing the funnel 24, while allowing the funnel 24 to rotate about the common center line of the pins 57, said common center line being at right angles to the center line of the stub shaft 59. The yoke element 74 therefore provides the two degrees of freedom required to have the funnel gimbaled at the end of the articulated arm 29. Two lugs 67 are fixed to the frame 11, each lug 67 having a hole sized to accept one end of a pin 68 with center line in the horizontal plane, said pin passing through the bearing assembly 72, the combination of lugs 67, pin 68 and bearing assembly 72 providing a joint allowing rotation of the articulated arm 29, yoke element 74 and funnel 24 in a vertical plane.

In the first embodiment, the rotation about the center line of the pin 68 is controlled by a hydraulic cylinder 27, the rod end clevis 75 of which is joined by pivot pin 61 (allowing rotation) to the eye bracket 60 which is fixed to the tube 71 at a point between the bearing assemblies 72 and 69. Two mounting lugs 63 are fixed to the frame 11, and the hydraulic cylinder 27 is joined to the lugs 63 by pivot pins 62 which allow for rotation, in what is termed a “trunnion mount”. The center line of the hydraulic cylinder 27 is at a right angle to the center line of the pins 62 and 68.

The entire assembly of funnel 24, yoke element 74, articulated arm 29 and hydraulic cylinder 27 is designed to allow a vertical range of motion for the funnel 24 of greater than sixty centimeters relative to the frame 11, and to allow an angular range of motion for the plane formed by lip 52 of funnel 24 of greater than 25 degrees from the horizontal in any direction.

The package of electronic air/liquid hydrocarbons/water level sensors 26 is fixed to the periphery 50 of the funnel 24, and by means of the electrical cable 80 communicates with the electronic control module 36. Control signals generated by the electronic control module 36 are sent via electrical cable 81 to an electro-hydraulic motor/pump/valving system 64, which communicates with and controls the extension of the hydraulic cylinder 27 by means of hydraulic lines 65 and 66 and thus the depth of funnel 24 relative to the level of the water surface and relative to the oil-water interface level.

The flexible hose 30 has fluid-tight connections, at one end with flange 90, and at the other end with flange 91. The flange 90 is joined by mechanical means to the flange 56, forming a fluid-tight connection, and the flange 91 is joined by mechanical means to the suction port 92 of the centrifugal pump 31, forming a fluid-tight connection. Flexible hose 30 thus forms a fluid passage for transporting spilled liquid hydrocarbons and water from the funnel 24 to the suction port 92. Centrifugal pump 31 is powered by a conventional variable-speed hydraulic motor whose speed is controlled by the oil/water level detection system 26 and control module 36 and may also be controlled by a flow meter installed in line with the pump.

Prior to the suction port 92 of the centrifugal pump there may be a pipe section (not shown) containing a diverter valve (or some mechanical means of diverting solids contained in the intake oil/water mixture) providing two outlet ports in a “Y” configuration, one outlet port connecting to the centrifugal pump and the other outlet port to a debris collection or holding chamber (not shown) which connects to a debris grinding chamber (not shown) containing two mechanical grinders with cutting blades of the preferred type known by the trade name “DWS 3000 Channel”, or other similar conventional grinders. The diverting and grinding mechanisms are activated when excessive debris (e.g. kelp, eel grass, bark or other floating debris) is encountered in the oil/water intake mixture which has passed through the primary and secondary debris barriers, that is, the external vertical debris bars 115 located on the four inlet areas, and the protective mesh covering the opening of funnel 124. The grinding chamber outlet port is connected by pressure- and fluid-tight means to a booster pump and conventional filter system, and then connects back to the main centrifugal pump 31. The diverter valve may be operated manually or automatically by the electronic control module 36 from signals received from a conventional solids detection device.

The centrifugal pump 31 is fixed by mechanical means to the frame 11. The discharge port 94 of the centrifugal pump 31 is joined by mechanical means to the oil/water centrifugal separator inlet distribution piping 32, forming a fluid- and pressure-tight connection, said piping 32 being in fluid communication with the inlet ports 95 of the oil/water centrifugal separator 33, which is fixed by mechanical means to the frame 11. Piping or tubing 34 is connected by fluid- and pressure-tight means to the liquid hydrocarbons discharge port 96 of the liquid hydrocarbons/water separator 33, and is in fluid- and pressure-tight communication with a floating, inflatable oil collection and storage tank 35 (shown in FIG. 6).

A high pressure water spray pump 23 is fixed by mechanical means to the frame 11. Pump 23 is operable by means of the action of the hydraulic motor 102, the source of water for the pump 23 being the environment. The water enters the pump 23 through the hydraulic pump suction port screen 103 and suction port 100. Piping 21 is connected by pressure- and fluid-tight means to the discharge port 101 of the pump 23 and by mechanical means to the frame 11. A multiplicity of removable spray nozzles 22 are installed along the piping 21 by fluid- and pressure-tight means, said nozzles 22 being arranged to each spray a fan-shaped jet of high-pressure water toward the center of the oil/water intake funnel 24, from an elevation of about 10 inches above the design water line 200 and at an angle of about 25 to 35 degrees to the water surface, sufficient nozzles being installed to cause the fan-shaped sprays to overlap prior to impact at the water surface.

A canopy 12, comprised of sheet and tube members in a generally dome-shaped configuration, the lower edge of which is in close proximity to and approximating the outline of the frame 11, is attached to the frame 11 by mechanical means, and provides protection from large waves for the components of the apparatus. The canopy also serves the function of reducing excess water from entering the oil/water intake funnel 24 in rough seas or when a large wave breaks over the apparatus.

In the first embodiment of the present invention, the frame 11 is generally covered by removable cladding plate members 110 which together act as a hull, the plates extending over the external portions of the frame bottom and a portion of the sides, the side plates 110 having a maximum upper vertical edge 111 at the four oil/water inlet areas several centimeters below the design water line 200. The hull cladding plates 110 are installed in a manner to allow the extension of the thruster systems, items 18 to 20, below the lowest portion of the frame 11 to the operating position of the thrusters. All of the connections between the frame 11 and plates 110 are fluid-tight, said plates being removable by bolts or the like for the purposes of inspection and maintenance of the apparatus 10.

An opening 122 in the bottom of the hull, bottom plate 110 allows for two water extraction pumps 120, operable by means of the action of a hydraulic motor 121, to discharge water from the volume enclosed by the frame 11 and hull plates 110 to the environment at large. The ultimate source of the water to be discharged is the environment at large external to the apparatus, said water flowing into the enclosed volume of the frame 11 in the areas between the water line 200 and the top edges 111 of the side cladding plates 110 through four main entry areas, one on each side of the apparatus between flotation tanks 13, and at either end of the apparatus. Where the upper edges 11 are formed on separate plates, the height of edges 111 can be manually adjusted and secured using bolts or the like. Thus the total cross-sectional area of the four external oil/water entry areas can be manually adjusted to the optimum level depending on the type of floating liquid hydrocarbons, flotation height of the apparatus, magnitude and condition of the oil spill, etc.

An enclosed, fluid and pressure-tight electronics module 36 contains the electronic hardware and software for operating the systems of the apparatus 10 in a coordinated manner to achieve the efficient and expeditious operation of the apparatus 10 in recovering spilled liquid hydrocarbons and other likewise immiscible substances from the water surface. This electronics module 36 also provides GPS guidance via GPS unit and serial bus 39 and real time telemetry for remote operation.

### Method of Operation of First Embodiment

When the apparatus 10 of the present invention is in full operation, rotation of the impeller of the centrifugal pump 31 by the action of the hydraulic motor 93 causes the liquid hydrocarbons and water present at the suction port 92 to be moved through the pump and discharged through the discharge port 94 of the centrifugal pump 31. The combination of low pressure created at the suction port 92 and gravity causes water and liquid hydrocarbons, if present in the funnel 24 and flexible hose 30, to flow toward the suction port 92. When the funnel 24 is submerged so that the funnel lip 52 is below the liquid hydrocarbons/water interface level, both liquid hydrocarbons and water flow over the lip 52 through the wire mesh and down the funnel surface 53 toward the funnel throat 54, and thence through the flexible hose 30 toward the suction port 92.

Due to the nature of wave action, the water surface within a circle circumscribing the flotation tanks 25 is rarely a plane surface and usually has an average slope inclined to the horizontal. The average depth of the funnel lip below the water surface is controlled in continuous fashion by the action of the hydraulic cylinder 27, in turn controlled by the action of the electro-hydraulic motor/pump/valve package 64, in turn controlled by the action of the systems in the electronics module 36, which receives its data signals from the air/liquid hydrocarbons/water level sensor package 26 mounted on the periphery 50 of the funnel 24. The gimbaled action of the yoke element 74 at the end of the articulated arm 29, in combination with the flotation tanks 25, provides a means whereby the inclination of the surface defined by the generally circular lip 52 of the funnel 24 will continuously follow the approximate average contour of the water surface near the funnel 24.

The liquid hydrocarbons and water discharged through the discharge port 94 of the centrifugal pump 31 passes into the separator inlet distribution piping 32, and thence into the separator 33 via the inlet ports 95. The separator acts to separate the liquid hydrocarbons and water, the water being discharged to the environment at large through the water extraction pumps 120, and the liquid hydrocarbons being conducted by means of piping 34 to the flexible oil storage tank 35.

The high pressure water spray system, items 21 to 23 and 100 to 102, provides a means whereby the flow of floating liquid hydrocarbons may be accelerated and concentrated for recovery at the funnel 24. The action of the fan-shaped water jets impinging, at an angle directed toward the funnel 24, on the oil or other liquid hydrocarbons floating on water surface 200 causes an acceleration of the flow of oil toward the funnel 24, said oil being replaced by oil from the surrounding environment (the oil tends to spread out over the water surface to areas of thinner oil cover). In addition, the flow of water in the jets causes an induced air flow to generally follow the water jets, said air flow aiding in causing the induced flow of liquid hydrocarbons over the water surface toward the funnel 24. The high pressure water jet system may be activated or de-activated automatically by the electronic control module 36 which receives the corresponding command signal from the oil/water level sensor 26 or by radio-transmitted signals from a helicopter, boom boat or support ship (described further below).

The operation of the water exhaust pumps 120 causes water from the surrounding environment to flow into the volume enclosed by the frame 11, over the edge 111 of hull cladding plates 110 at each of the four external oil/water inlet areas. The presence of the cladding plates 110 forming the hull of the vessel restricts the inflowing water to the several centimeters below the water line 200 and above the upper edge 111 of cladding plates 110. The flow of water across the four inlet areas over the edges 111 induces the flow of additional liquid hydrocarbons from the surrounding environment toward the funnel 24. Both this system and the high pressure spray system are intended to increase the efficiency of the apparatus and increase the rate of liquid hydrocarbons recovery. Vertically-mounted debris barrier grid bars 115, spaced approximately 15 to 20 centimeters apart, prevent large floating debris from nearing the funnel 24. Funnel 24 is further provided with the afore-mentioned screen or mesh to prevent debris from entering and clogging the centrifugal pump 31 or centrifugal separator 33. Cutting knives may also be provided in the flow of tube 30 adjacent pump 31 to mulch or pulverize algae, kelp or eel grass which may threaten to clog the pump 31 or separator 33. A double grinder debris processing system of the type sold under the trade-mark DWS 3000 CHANNEL is preferred for this purpose. An obstacle detection sonar package 130, known as a multiple transducer eco-sounder obstacle avoidance system, preferably using 8 to 12 transducers located around the hull of the vehicle, is also provided to allow the device to avoid colliding with large underwater obstacles, reefs, rocks, sand bars, ocean floor etc.

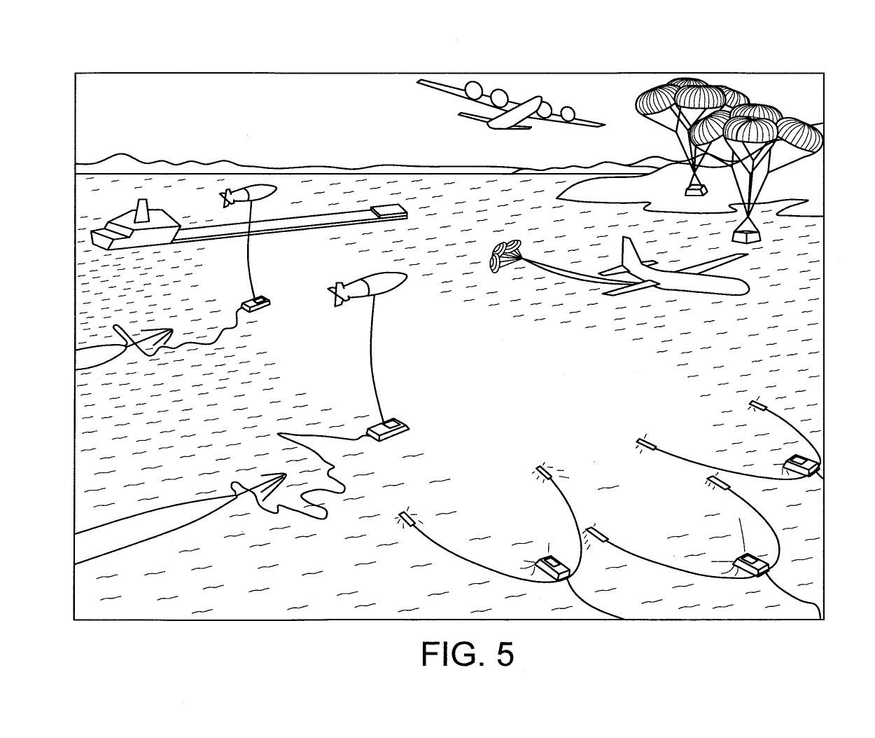

FIGS. 5 and 6 illustrate two airborne oil spill containment and recovery systems utilizing the liquid hydrocarbons recovery apparatus of the invention. As shown in FIG. 5, The AEROS System is parachute deployed from C-130 aircraft. Fleet management software plus command and control software permit control of deployed systems from aircraft or via satellite from a command center located anywhere. The AEROS system is completely unmanned when in operation, thus eliminating the risks to human operators created by the toxic & deadly fumes released by crude oil during the early hours of a spill. The self-propelled oil spill recovery vehicles called “Hydra-Head AUVs” 10 very quickly and efficiently separate the oil from the water and pump the recovered oil into the large floating oil bladders 35. AEROS can operate in adverse weather, day or night, whereas conventional systems are limited to daylight and good visibility.

In FIG. 5, an oil tanker is shown as having run aground on rocks and is disgorging crude oil slick 304 on the surface of a body of water 306. One or more military cargo aircraft, preferably the LOCKHEED HERCULES C-130B aircraft, are used to deploy in flight the various components of the system which would be dropped from a height greater than 300 meters by means of appropriate conventional drop parachutes. Self-inflating conventional oil spill containment booms 310, such as those sold under the trade-mark ZOOOM BOOM and/or 3M FIRE BOOM, are deployed from aircraft 308 using parachutes and roll-on, roll-off ejection systems. High-impact-resistant “boom boats” 312 are also deployed using parachutes. Weighing roughly 4 to 6 tons each, the boom boats 312 are designed to withstand high-speed impact with the surface of the water. The boom boats are operated by remote control to robotically hook up to the containment booms 310, and tow them into the desired positions at a safe distance from tanker 300 or from the shore. The self-propelled, remote-controlled oil spill recovery vehicle (ROV) 10 of the invention is also airborne deployable using parachute 305. The cargo aircraft 308 may also be equipped with a roll-on roll-off oil spill dispersant delivery or spraying system such as that sold under the trademark ADDSPAC of Beigert Aviation or similar systems of Conair Aviation or Aerounion Inc. The air-borne-deployable boom boats 312 may be of a design similar to boat known as “oil spill skimming vessels”. Such boats may be equipped with water jet propulsion systems of the type sold under the trademark SCHOTTEL.

A conventional hydrocarbon remote sensing system such as that of MacDonald Dettwiler sold under the trademark MEIS, or similar system, may be installed on helicopter and can be used interfaced with a conventional dynamic positioning system to control the remote control boom boats 312 and liquid hydrocarbons recovery vehicle 10. A helicopter may also be used for deployment of an approved oil spill ignition and in situ burning system such as that sold under the trademark HELI-TORCH. The helicopter may also be used to deploy an approved oil spill dispersant (or hydrocarbon emulsifier) spraying system such as that sold by CONAIR AVIATION. The helicopter may also be equipped with a remote-controlled self-righting overboard survivor rescue system such as that sold under the trademark JET NET or similar system. An airborne hydrocarbon remote sensing system is disclosed for example in U.S. Pat. No. 3,899,213 issued Aug. 12, 1975 to the U.S. Department of Transportation. The remote control features of the system disclosed herein allow it to be deployed in adverse conditions which would be inaccessible using manned crews, as well as permitting full operation in conditions of limited visibility, fog, night-time, etc.

An airborne-deployable liquid hydrocarbons storage device 35 consists of a floating expandable flexible storage tank constructed of inter-polymer ethylene alloys. One airborne system would consist of several airborne-deployable storage tanks which would preferably have a combined capacity on the order of 450,000 gallons (10,000 barrels). In the system shown in FIG. 5, the liquid hydrocarbons recovery vehicles 10 supply recovered liquid hydrocarbons directly to the storage tanks 35, and again in the preferred system the navigation and hook-up is achieved either manually by crew or by remote control as previously described.

In the system shown in FIG. 6, a support ship 320 controls the remote operation of the liquid hydrocarbons recovery vehicles 10, boom boats 312, and booms 310, all of which have been air dropped. In this system, in addition to the primary oil/water separation in each oil recovery ROV, support ship 320 is also equipped with a conventional water purification system to purify the separated water before returning it to the environment. The recovered, separated oil is transferred from large oil holding tanks on board ship 320 by conventional high-volume “in-line” centrifugal oil pumps of the type sold under the trademarks SULZER BINGHAM or BYRON JACKSON to floating tanks 35. Boom Tugs 312 and liquid hydrocarbon recovery vehicles 10 are provided with real time telemetry and control, allowing their function to be completely remote. Navigation is supported by GPS guidance via GPS unit and serial bus 39, enabling night time operation. The command link to the GPS serial bus 39 allows a pattern following mode which will allow the liquid hydrocarbons recovery vehicle 10 to follow a defined course or head to a target location. Simultaneous coordinated control of multiple liquid hydrocarbons recovery vehicles 10 over the command link can be enabled, allowing a coordinated liquid hydrocarbons cleanup effort. Waypoint navigation can be used to allow pre-defined patterns for liquid hydrocarbon retrieval or rendezvous points for recovery of the liquid hydrocarbon recovery vehicle 10. Telemetry, via satcom communication, will allow live status updates regarding remaining holding tank 35 capacity, remaining fuel, and location of the liquid hydrocarbons recovery vehicle 10.

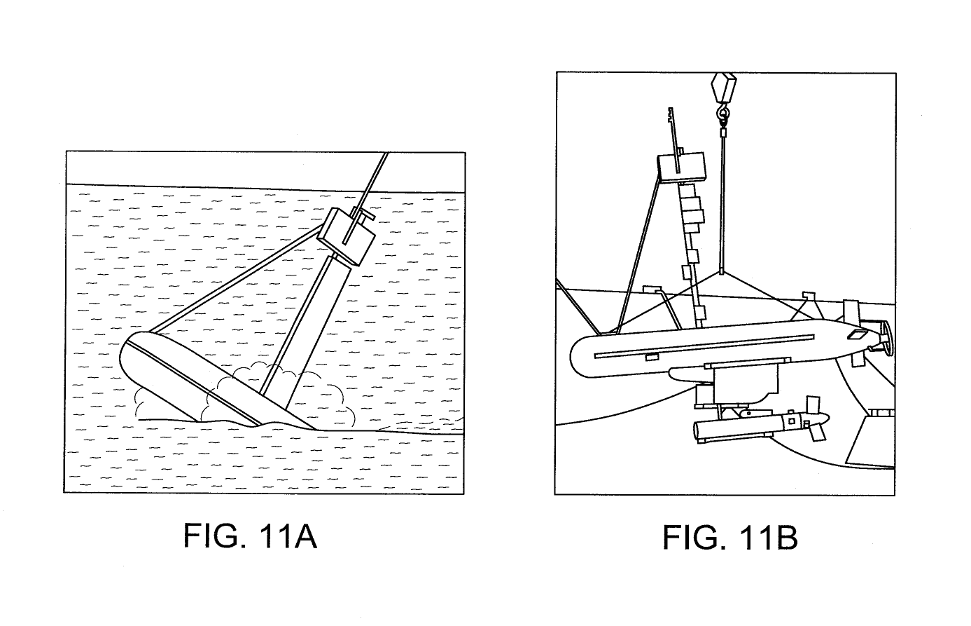

In the ship-mounted version of the invention the oil recovery ROV vehicles 10 are attached to the support/processing ship by floating flexible conventional high-pressure oil hoses. Each recovery vehicle has sufficient hose to reach in any direction up to approximately 250 m. The recovery ROV's are deployed from the ship by an overhead conventional hanging rail system and mechanical-hydraulic cranes preferably of the “gantry” type, shown in FIG. 11. The hose for each oil recovery ROV is deployed by a vertically-mounted, hydraulically-operated drum in such a manner that the flow of oil is uninterrupted as the ROV is propelled to or from the ship. The drum automatically maintains a preset recoil tension on the hose to minimize slack or excess hose between the ship and the oil recovery ROV 10.

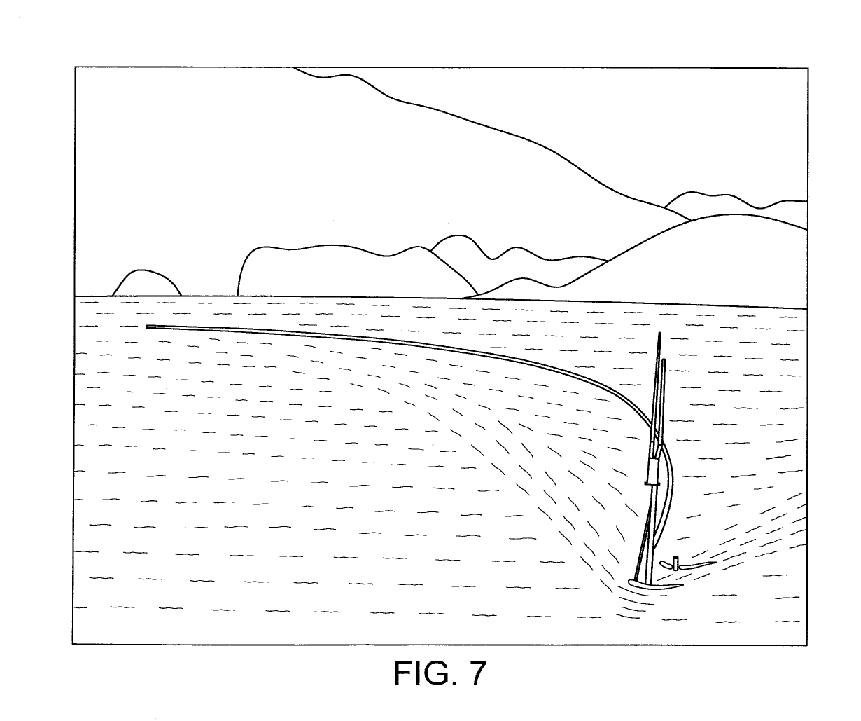

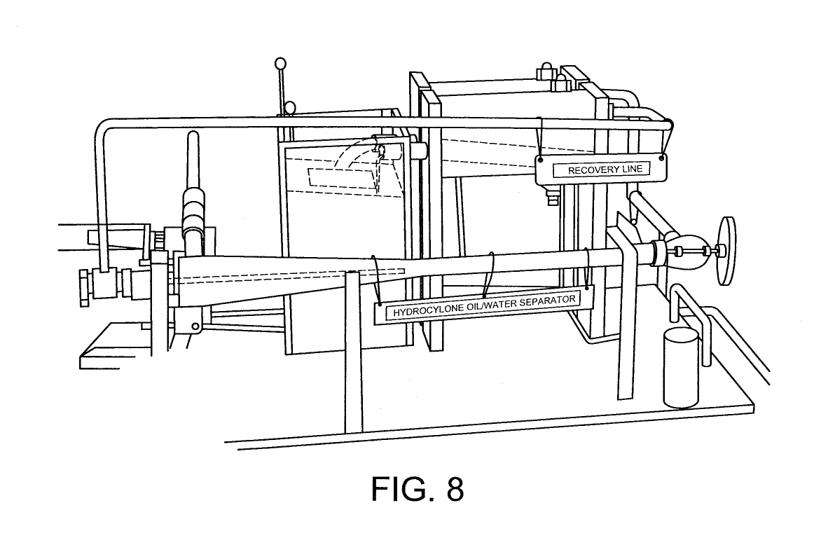

FIG. 7 illustrates a robotic AUV submarine vehicle towing an oil spill containment boom during sea trials. A suitable robotic AUV submarine vehicle is the “Dolfin 350” designed and built by ISE International Submarine Engineering Limited. This AUV vehicle is an alternative to the AEROS airborne version which is modified and re-engineered to enable parachute deployment from C-130 Hercules, Antonov, and similar aircraft. The above AUV is controlled by GPS-satellite systems developed by ISE International Submarine Engineering Limited. In FIG. 8 illustrates a demonstration of the hydrocarbon recovery vehicle 10 oil-water separation system. All the air and oil molecules are instantly squeezed into the central core of the spinning liquids. Due to a controlled pressure differential at each end of the separation chamber, all the oil molecules flow to the left while the separated clean water all flows to the right.

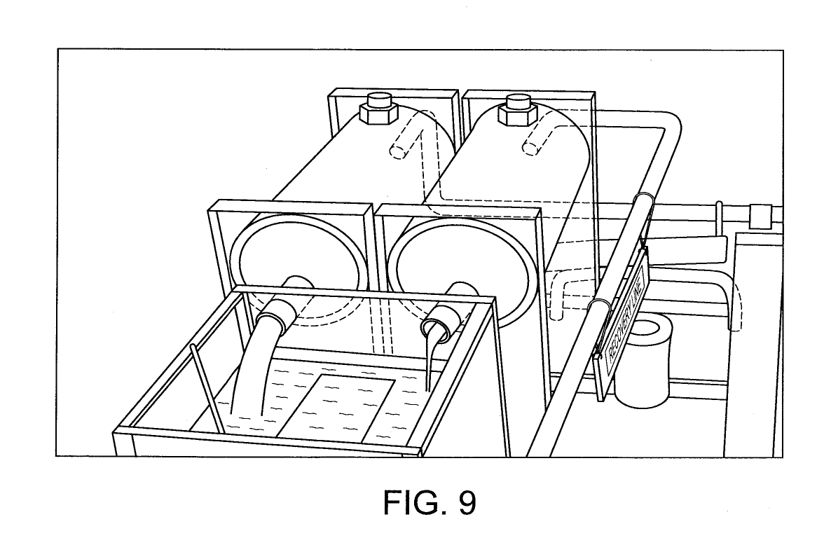

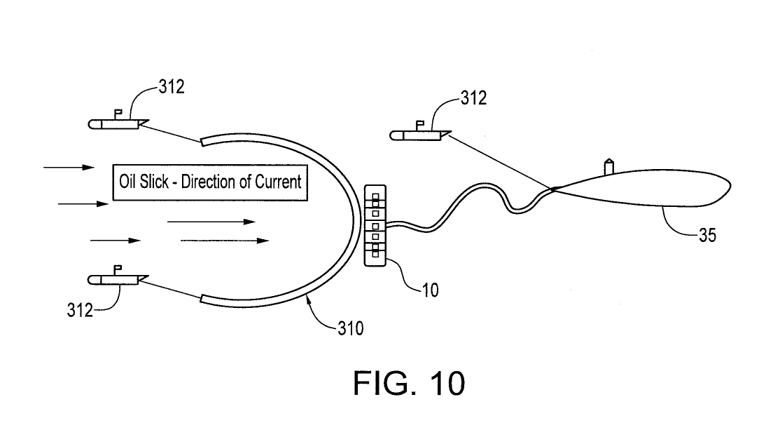

FIG. 9 shows a demonstration model of the hydrocarbon recovery vehicle 10 Oil-Water Separation System output. Clean water exits from the water collection chamber (left side) after being separated from the oil-water mixture as shown in the previous photo. The black oil exits from the oil collection chamber (right side) after being separated from the oil-water mixture. Both liquids are dumped into the oil spill mixing tank and recycled via the high pressure pump to flow again through the system in a “closed circuit”. The present system can effectively separate the oil and water even with sudden surges in the oil content of the liquid intake stream. Each AEROS Hydra-Head AUV oil spill recovery vehicle will preferably have the capacity to process up to 2,000 gallons per minute=120,000 gallons/hour. For a catastrophic oil spill, 10 or 20 systems may be deployed. Twenty AEROS Systems could then jointly process up to 2,400,000 Million Gallons/Hour. The percentage of oil to sea water being processed/separated depends on the sea state and numerous other factors. The internal separation efficiencies of the AEROS oil-water separation system are not affected by the up and down motion of the vehicle caused by ocean waves. FIG. 10 shows the AEROS Airborne Robotic Oil Spill Recovery System, depicting the relative arrangement of Boom Tugs 312, Hydrocarbon recovery vehicle 10, Floating oil collection tank 35, and the oil spill containment boom 310. All components of the AEROS System are parachute deployable from C-130 Hercules or similar aircraft. Thus, response time to start recovery operations at the site of the disaster is approximately 20 times faster than all conventional ship borne response systems.

The system herein described can be operated in a mode similar to the fire hall response to a fire alarm. The airborne elements of the system are kept on alert at an airport convenient to the oil tanker coastal shipping lane. The system can thus be deployed faster than existing systems and in conditions which do not allow the deployment/operation of known systems.

### Description of a Second Embodiment of the Invention

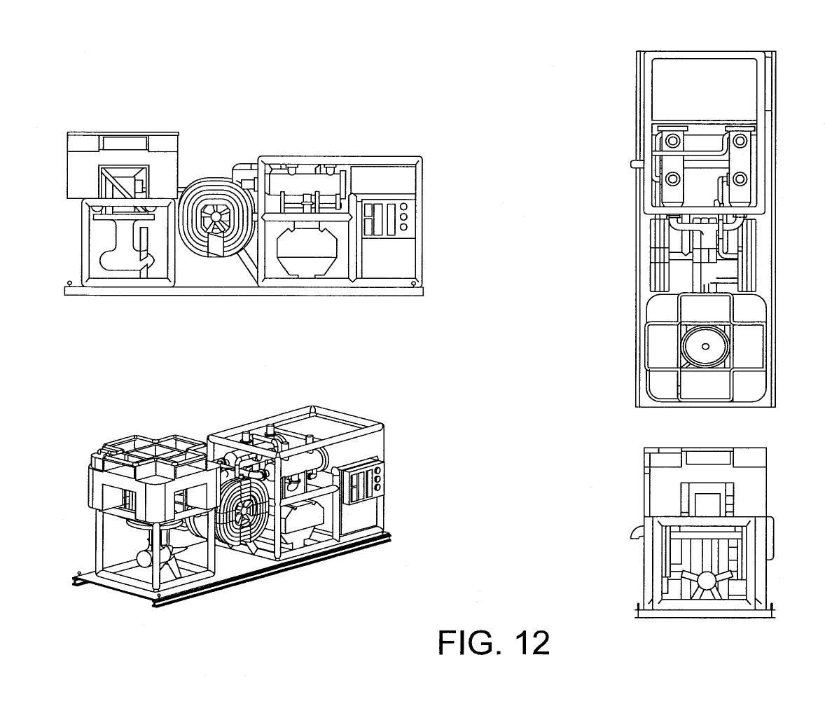

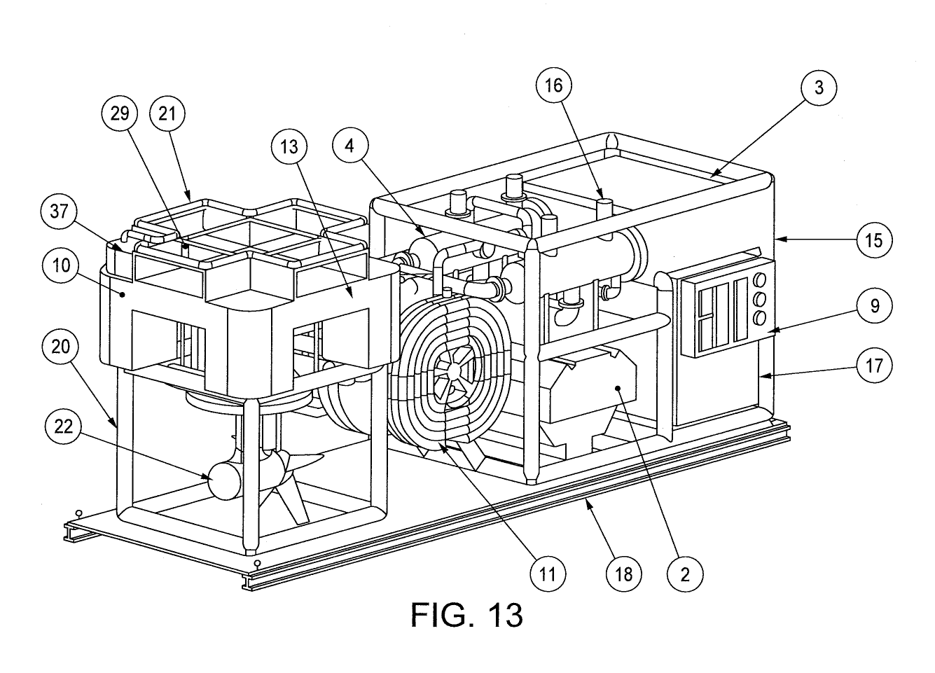

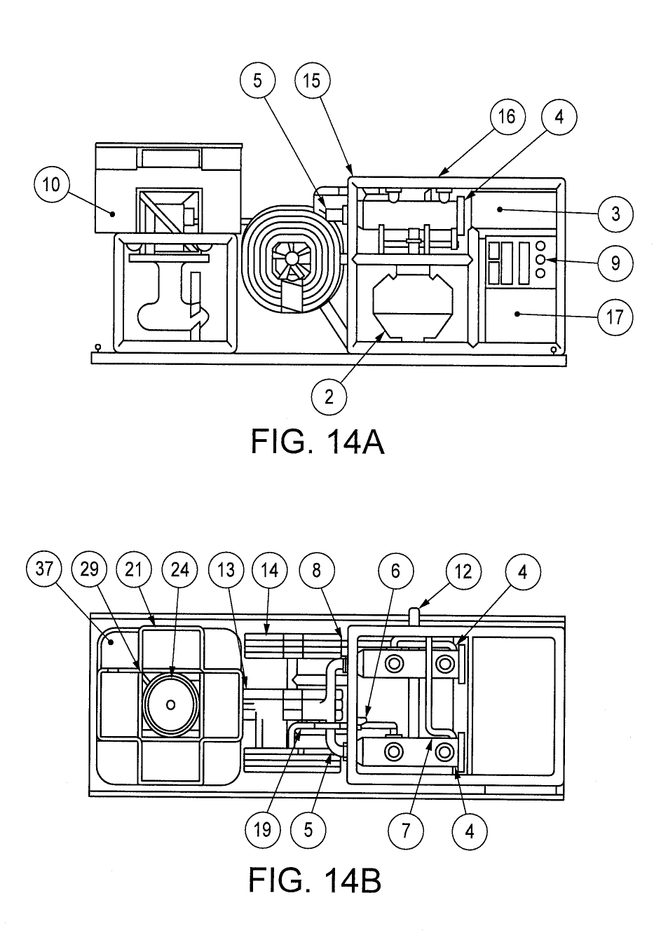

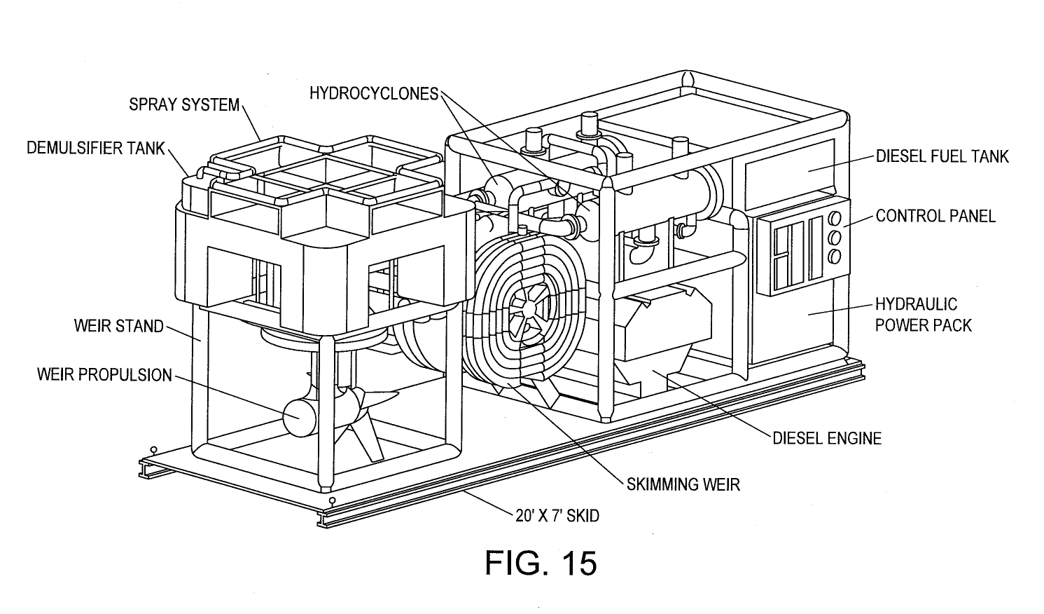

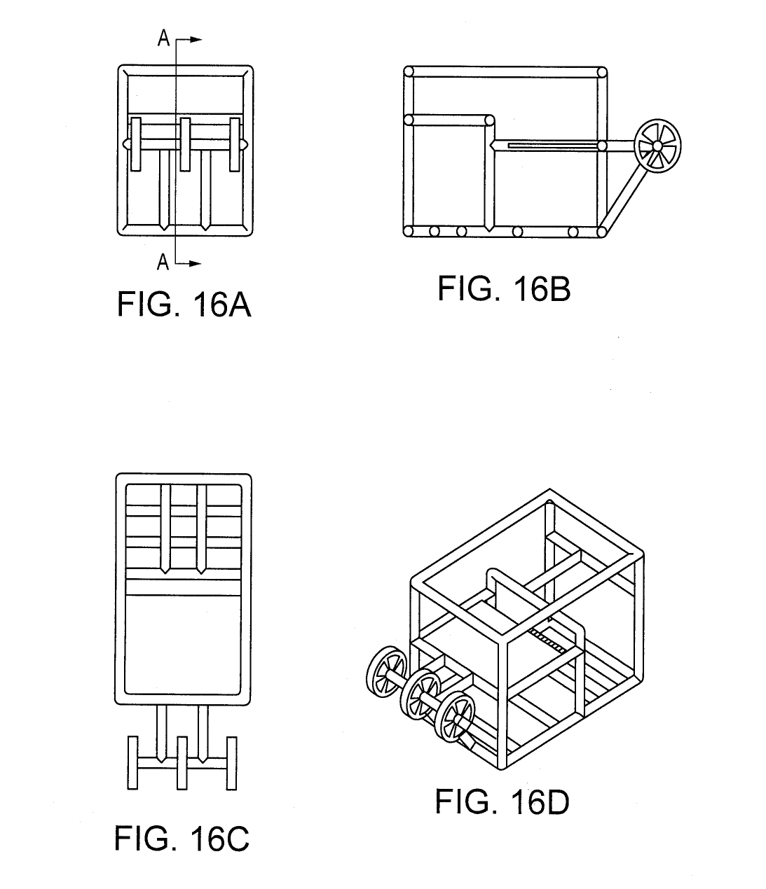

FIGS. 12 through 16 show the overall configuration of the liquid hydrocarbons collection and separation apparatus in accordance with a second embodiment of the present invention. The apparatus includes generally a frame 15, diesel engine or other internal combustion power source 2, a fuel tank for the said internal combustion power source 3, hydrocyclone oil-water separator 4, oil-water intake pipes 5, a hydraulic pump 6, internal oil-water pipes 7, oil discharge pipes 8, an electrical control panel to manage the oil-water flow 9, a weir skimmer, in the second embodiment, the RBS-40DI skimmer manufactured by Aquaguard 10, a spool to support and store the oil-water intake line 11, pipes for the residual discharge 12, a water hose for clean water discharge to return to the environment 13, an oil discharge line for separated oil for storage 14, vent lines and Pressure Safety Valves for hydrocyclone operation 16, an enclosed power-pack, in one embodiment, the PP27 Aquaguard powerpack 17, a 20′×7′ trailer mounted skid 18, and infeed lines 19, a chemical demulsifier tank 37 with control valve (not shown) as described in the first embodiment, a 360° steerable Z-drive, in one embodiment, the Olympic Z-drive manufactured by Olympia 22, the high-pressure water spray system as described in the first embodiment 21, the liquid hydrocarbons/water collection funnel system elements as described in the first embodiment 24, the weir support 20 which is fixed to the skid 18 for the purposes of transport, and the articulated arm 29 as described in the first embodiment.

While it is contemplated for the preferred embodiment that the power source 2 is diesel powered, in which case the tanks 3 hold diesel fuel, it is apparent that other sources of power such as gasoline or electricity may be used. In addition, solid polymer fuel cells utilizing cryogenic oxygen and hydrogen as fuel may also be used instead of a diesel powered internal combustion engine. The power source 2 provides hydraulic power to the various devices.

Centrifugal hydrocyclone oil-water separator 4 is preferably of the type disclosed in U.S. Pat. No. 4,859,347 issued Aug. 22, 1989 to Simon et al.

In the preferred embodiment, frame 15 is a structure, comprised of welded tubing, of a generally box-like nature, to which are attached by mechanical fastener means the power source 2, fuel tanks 3, hydrocyclones 4, control panel 9, hydraulic power pack 17 and skid 18.

Control signals generated by the electronic control panel 9 are sent via electrical cable to an electro-hydraulic motor/pump/valving system 6, and to the electro-hydraulic motor/pump/valve package 64 (not shown) which will control the funnel 24 depth as described in the first embodiment, based on desired flow rates at the hydrocyclones 4 and weir skimmer 10.

The flexible oil-water intake line 5 and 11, hydraulic pump 6, oil-water connection lines 7, and discharge lines 8, 12, 13 and 14 have fluid-tight connections. Lines that are external to the frame 15 are stored on spools 11, 12 and 13, which are joined by mechanical means to the frame 15. The system thus forms a fluid passage for transporting spilled liquid hydrocarbons and water from the weir 10 to the storage tanks connected to the oil discharge line 14 and residual discharge 12. Clean water discharge 13 is returned to the environment during system operation. The hydraulic pump 6 is powered by a conventional variable-speed hydraulic motor whose speed is controlled by the control module 9 and may also be controlled by a flow meter installed in line with the pump.

The hydrocyclones 4 have incorporated within them a means of separating small waste solids which are diverted to the residual discharge line 12. A screen is installed at the weir (not shown) to prevent the induction of large solids or foreign objects, or may be diverted through a ‘Y’ bend (not shown) sending debris to two mechanical grinders with cutting blades of the preferred type known by the trade name “DWS 3000 Channel”, or other similar conventional grinders. The diverting and grinding mechanisms are activated when excessive debris (e.g. kelp, eel grass, bark or other floating debris) is encountered in the oil/water intake mixture which has passed through the primary and secondary debris barriers, that is, the said screen. The grinding chamber outlet port is connected by pressure- and fluid-tight means to a booster pump and conventional filter system, and then connects back to the main centrifugal pump 6. The diverter valve may be operated manually or automatically by the electronic control module 9 from signals received from a conventional solids detection device.

The electronics module and control panel 9 contains the electronic hardware and software for operating the systems of the oil-water separation assembly in a coordinated manner to achieve the efficient and expeditious operation in recovering spilled liquid hydrocarbons and other likewise immiscible substances from the water surface.

### Method of Operation of Second Embodiment

When the oil-water separation assembly of the present invention is in full operation, rotation of the hydraulic pump 6 by the action of the power source 2 causes the liquid hydrocarbons and water present at the suction port of the weir 10 to be moved through the pump and processed through the hydrocyclone oil water separators 4 and discharged through the residual discharge line 12, clean water discharge line 13 and oil water discharge line 14. The vent lines 16 allow any unexpected pressure to be relieved safely.

Fluids and material passed through the residual discharge line 12 are collected in a separate holding tank (not shown) for safe disposal. Oil that has been separated from the oil-water mix proceeds through the oil water discharge line 14 to an oil holding tank (not shown). Water from the oil-water mix is passed through the clean water discharge lines 13 and returned to the environment at large.

A vertically-mounted debris barrier grid (not shown) on the weir 10 prevent large floating debris from entering the oil-water intake lines 5. The weir 10 is further provided with the aforementioned screen or mesh to prevent debris from entering and clogging the centrifugal pump 6 or oil-water separator 4. Cutting knives may also be provided in the flow of tube 5 adjacent pump 6 to mulch or pulverize algae, kelp or eel grass which may threaten to clog the pump 6 or separator 4. A double grinder debris processing system of the type sold under the trade-mark DWS 3000 CHANNEL is preferred for this purpose. An obstacle detection sonar package (not shown), known as a multiple transducer eco-sounder obstacle avoidance system, preferably using 8 to 12 transducers located around the hull of the weir, may also be provided to allow the device to avoid colliding with large underwater obstacles, reefs, rocks, sand bars, ocean floor etc. Remote control and guidance of the propulsion of the device is accomplished in the same manner as in the first embodiment.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within its true spirit and scope.

What is claimed is:

1. A remotely-guided, self-propelled apparatus for collecting and separating liquid hydrocarbons from the surface of a body of water comprising:
a) a housing forming an interior space for receiving a volume of liquid and provided with flotation means, the housing having one or a plurality of entrance apertures adjacent the water surface adapted to admit an uppermost layer of liquid hydrocarbons and water from the water surface to the interior of the housing, and an exit aperture adapted to permit the flow of water from the housing;
b) means within the housing for collecting a flow of liquid from the surface layers of the liquid hydrocarbons and water in the interior of the housing and directing the liquid to first pump means;
c) means for maintaining said means for collecting at a selected depth;
d) means for measuring the thickness of hydrocarbons on said water surface and communicating said measurement to said means for maintaining said means for collecting at a selected depth;
e) second pump means for evacuating water from said exit aperture; and
f) a liquid hydrocarbons-water separator mounted in said housing, and connected to means for discharging separated liquid hydrocarbons from the housing to a means for storage of recovered separated liquid hydrocarbons;
g) variable direction propulsion means;
h) propulsion control means for receiving remote signals and controlling the direction and force of said propulsion means according to said remotely-received signals; and
g) geographic positioning system means for sensing the geographic position of the apparatus and communicating said position to said propulsion control means.

2. The apparatus of claim 1 wherein said means within the housing for collecting a flow of liquid from the surface layers of the liquid hydrocarbons and water comprises a floating intake and said means for measuring the thickness of hydrocarbons on said water surface comprise hydrocarbon sensors mounted on said floating intake communicating with said means for maintaining said means for collecting at a selected depth.

3. The apparatus of claim 1 further comprising sonar means for detecting floating objects and communicating said detection to said propulsion control means.

4. The apparatus of claim 1 wherein said means for maintaining said means for collecting at a selected depth comprises a funnel depth control cylinder connected to said floating intake weir skimmer and for raising or lowering said floating intake weir skimmer in response to said communication from said means for measuring the thickness of hydrocarbons.

5. A method of collecting liquid hydrocarbons from the surface of water, and separating the liquid hydrocarbons from the water comprising:
a) deploying a plurality of remotely-guided self-propelled floating liquid hydrocarbons collection and separation apparatus as claimed in claim 1, floating liquid hydrocarbons retention boom means and floating liquid hydrocarbons storage means;
b) moving said liquid hydrocarbons boom means to contain the liquid hydrocarbons;
c) moving the liquid hydrocarbons collection and separation apparatus by remote guidance into the contained liquid hydrocarbons and operating the apparatus to separate the liquid hydrocarbons from the water; and
d) pumping the separated liquid hydrocarbons into the floating liquid hydrocarbons storage means.

6. The method of claim 5 wherein the liquid hydrocarbons boom means, liquid hydrocarbons collection and separation apparatus and liquid hydrocarbons storage means are dropped onto the surface of water from the air by aircraft, or by ship or tractor-trailer.

7. Remotely-guided, self-propelled apparatus for collecting and separating liquid hydrocarbons from the surface of a body of water comprising:
a) a weir skimmer for the collection of a volume of liquid adapted to admit an uppermost layer of liquid hydrocarbons and water from the water surface to the skid mounted oil-water separator, and an exit aperture adapted to permit the flow of water from the housing to return to the environment and oil from the housing to separate storage tanks;
b) means within the housing for collecting a flow of liquid from the surface layers of the liquid hydrocarbons and water from the weir and directing the liquid to a first pump;
c) variable direction propulsion means;
d) propulsion control means for receiving remote signals and controlling the direction and force of said propulsion means according to said remotely-received signals; and
e) geographic positioning system means for sensing the geographic position of the apparatus and communicating said position to said propulsion control means;
wherein the apparatus also includes a liquid hydrocarbons-water separator mounted in the housing, and connected to means for discharging separated liquid hydrocarbons from the housing to a means for storage of recovered separated liquid hydrocarbons.

8. A method of collecting liquid hydrocarbons from the surface of water, and separating the liquid hydrocarbons from the water comprising:
a) providing a floating liquid hydrocarbons collection weir and skid mounted separation apparatus assembly as claimed in claim 7, and land based hydrocarbons storage means;
b) operating the apparatus to separate the liquid hydrocarbons from the water; and
c) pumping the separated liquid hydrocarbons into the land based liquid hydrocarbons storage means;
wherein the liquid hydrocarbons weir is dropped onto the surface of water from a skid by a hydraulic arm or small crane.
